(19) United States
(12) Patent Application Publication
(10) Pub. No.: US 2020/0067133 A1
(43) Pub. Date: Feb. 27, 2020

(54) ALL-SOLID-STATE LITHIUM ION SECONDARY BATTERY

(71) Applicant: TDK CORPORATION, Tokyo (JP)

(72) Inventors: Hiroshi SATO, Tokyo (JP); Keiko TAKEUCHI, Tokyo (JP); Masayuki MUROI, Tokyo (JP); Taisuke MASUKO, Tokyo (JP); Hisaji OYAKE, Tokyo (JP); Tomohiro YANO, Tokyo (JP)

(73) Assignee: TDK CORPORATION, Tokyo (JP)

(21) Appl. No.: 16/491,454

(22) PCT Filed: Mar. 29, 2018
(86) PCT No.: PCT/JP2018/013125

§ 371 Date: Sep. 5, 2019

(30) Foreign Application Priority Data
Mar. 31, 2017 (JP) 2017-069453

(51) Int. Cl. H01M 10/0562; H01M 10/0525; H01M 2/30; H01M 4/136; H01M 4/58; H01M 4/64; H01M 10/0585

(52) U.S. Cl. CPC H01M 10/0562; H01M 10/0525; H01M 2/30; H01M 2300/0065; H01M 4/58; H01M 4/64; H01M 10/0585; H01M 4/136

(57) ABSTRACT

An all-solid-state lithium ion secondary battery including: a layered body in which a plurality of electrode layers are laminated with a solid electrolyte layer therebetween, a current collector layer and an active material layer being laminated in each of the electrode layers; and a terminal electrode that is formed such that the terminal electrode is in contact with a side surface of the layered body from which end surfaces of the electrode layers are exposed, in which the terminal electrode contains Cu, and Cu-containing regions are formed at grain boundaries that are present near the terminal electrode among grain boundaries of particles that form the active material layers and the solid electrolyte layer.

### TECHNICAL FIELD

The present invention relates to an all-solid-state lithium ion secondary battery.

The application is based upon and claims the benefit of priority from Japanese Patent Application No. 2017-69453, filed Mar. 31, 2017, the entire contents of which are incorporated herein by reference.

### BACKGROUND ART

Lithium ion secondary batteries have been used widely as power sources for small mobile devices such as mobile phones, laptop personal computers (PC), and mobile information terminals (personal digital assistants (PDA)), for example. Lithium ion secondary batteries that are used in mobile small devices have been required to have reduced sizes, reduced thicknesses, and improved reliability.

In the related art, lithium ion secondary batteries using organic electrolyte solutions as electrolytes and lithium ion secondary batteries using solid electrolytes are known as lithium ion secondary batteries. Lithium ion secondary batteries using solid electrolytes as electrolytes (all-solid-state lithium ion secondary batteries) have advantages such as a high degree of freedom in designing battery shapes, being easily reduced in size and thickness, and high reliability due to no leakage of electrolytes.

As an all-solid-state lithium ion secondary battery, there is an example disclosed in Patent Document 1. Patent Document 1 discloses an all-solid-state lithium ion secondary battery in which a positive electrode terminal that is connected to a positive electrode layer and/or a negative electrode terminal that is connected to a negative electrode layer have structures in which electroconductive matrixes made of electroconductive materials carry active materials and a ratio (Sd/Sk) between an area (Sd) of a region of the electroconductive materials and an area (Sk) of the region of the active materials in a section of the positive electrode terminal and/or the negative electrode terminal falls within a range of 90:10 to 40:60. According to the all-solid-state lithium ion secondary battery disclosed in Patent Document 1, strong bonding is obtained between the positive electrode layer and the positive electrode terminal and between the negative electrode layer and the negative electrode terminal.

### CITATION LIST

### Patent Literature

### [Patent Document 1]

Japanese Unexamined Patent Application, First Publication No. 2011-198692

### SUMMARY OF INVENTION

### Technical Problem

However, bonding strength between a layered body in which a plurality of electrode layers are laminated with a solid electrolyte layer therebetween, a current collector layer and an active material layer being laminated in each of the electrode layers; and a terminal electrode that is formed such that the terminal electrode is in contact with a side surface of the layered body is insufficient in an all-solid-state lithium ion secondary battery in the related art. Therefore, there is a disadvantage that the terminal electrode easily peels off from the layered body due to impact from the outside. Also, since the terminal electrode easily peels off from the layered body due to a change in volume of the active material layers that accompanies charging and discharging, sufficient cycling characteristics are not achieved.

The invention was made in view of the aforementioned problems, and an object thereof is to provide an all-solid-state lithium ion secondary battery with satisfactory bonding strength between a layered body in which a plurality of electrode layers are laminated with a solid electrolyte layer therebetween, a current collector layer and an active material layer being laminated in each of the electrode layers; and a terminal electrode formed such that the terminal electrode is in contact with a side surface of the layered body.

### Solution to Problem

The inventors have conducted intensive studies in order to solve the aforementioned problem.

As a result, the inventors have confirmed that it is only necessary to form Cu-containing regions at grain boundaries that are present near a terminal electrode among grain boundaries of particles that form active material layers and a solid electrolyte layer in the layered body by using a material containing Cu as a material for the terminal electrode and controlling sintering conditions when the terminal electrode is formed. Also, the inventors have confirmed that the bonding strength between the active material layers, the solid electrolyte layer, and the terminal electrode in the layered body becomes high by forming the Cu-containing regions at the active material layers and the solid electrolyte layer in the layered body and have achieved the invention.

That is, the invention relates to the following invention.

### Solution to Problem

According to an aspect of the invention, there is provided an all-solid-state lithium ion secondary battery including: a layered body in which a plurality of electrode layers are laminated with a solid electrolyte layer therebetween, a current collector layer and an active material layer being laminated in each of the electrode layers; and a terminal electrode that is formed such that the terminal electrode is in contact with a side surface of the layered body from which end surfaces of the electrode layers are exposed, in which the terminal electrode contains Cu, and Cu-containing regions are formed at grain boundaries that are present near the terminal electrode among grain boundaries of particles that form the active material layers and the solid electrolyte layer.

In the all-solid-state lithium ion secondary battery according to the aforementioned aspect, the terminal electrode may contain at least one selected from the group consisting of V, Fe, Ni, Co, Mn, and Ti.

In the all-solid-state lithium ion secondary battery according to the aforementioned aspect, a shortest distance between a border of the active material layers or the solid electrolyte layer and the terminal electrode and a Cu-containing region, which extends from the border toward a side of the active material layers or the solid electrolyte layer; and formed in a furthest location from the boundary may be 0.1 to 50

In the all-solid-state lithium ion secondary battery according to the aforementioned aspect, the solid electrolyte layer may contain a compound represented by Formula (1) below:

Li_{f}V_{g}AlₕTiᵢPⱼO₁₂ (1)

wherein f, g, h, i, and j in Formula (1) are numbers that satisfy 0.5≤f≤3.0, 0.01≤g <1.00, 0.09<h≤0.30, 1.40<i≤2.00, and 2.80≤j≤3.20, respectively.

In the all-solid-state lithium ion secondary battery according to the aforementioned aspect, at least one electrode may include an active material layer containing a compound represented by Formula (2) below:

LiₐV_{b}Al_{c}Ti_{d}P_{c}O₁₂ (2)

wherein a, b, c, d, and e in Formula (2) are numbers that satisfy 0.5≤a≤3.0, 1.20<b≤2.00, 0.01≤c<0.06, 0.01≤d<≤0.60, and 2.80≤e≤3.20, respectively.

In the all-solid-state lithium ion secondary battery according to the aforementioned aspect, a relative density of the electrode layer and the solid electrolyte layer may be equal to or greater than 80%.

### Advantageous Effects of Invention

The all-solid-state lithium ion secondary battery according to the aspect of the invention has satisfactory bonding strength between the layered body in which the plurality of electrode layers are laminated with the solid electrolyte layer therebetween, a current collector and an active material layer being laminated in each of the electrode layers; and the terminal electrode that is formed such that the terminal electrode is in contact with the side surface of the layered body. Therefore, it is possible to prevent the terminal electrode from peeling off from the layered body due to impact from the outside. Also, since it is difficult for the terminal electrode to peel off from the layered body due to a change in volume of the active material layer that accompanies charging and discharging, satisfactory cycling characteristics are achieved.

### BRIEF DESCRIPTION OF DRAWINGS

FIG. 1 is a schematic sectional view of an all-solid-state lithium ion secondary battery according to a first embodiment.

FIG. 2 is a scanning electron microscope (SEM) photo of an all-solid-state battery in Example 2.

FIG. 3 is an enlarged photo showing a part of FIG. 2 in an enlarged manner.

FIG. 4A is a photo of a field of view when observing a grain boundary of a second layer that is present near a third layer in a cut surface after a specimen after a heat treatment is cut.

FIG. 4B is a photo of a Cu mapping result of cutting a specimen after a heat treatment and performing energy dispersive X-ray spectroscopy (EDS) on a grain boundary of a second layer that is present near a third layer in a cut surface.

FIG. 4C is a photo of a V mapping result of cutting a specimen after a heat treatment and performing energy dispersive X-ray spectroscopy (EDS) on a grain boundary of a second layer that is present near a third layer in a cut surface.

FIG. 4D is a photo of an Al mapping result of cutting a specimen after a heat treatment and performing energy dispersive X-ray spectroscopy (EDS) on a grain boundary of a second layer that is present near a third layer in a cut surface.

FIG. 4E is a photo showing a Ti mapping result of cutting a specimen after a heat treatment and performing energy dispersive X-ray spectroscopy (EDS) on a grain boundary of a second layer that is present near a third layer in a cut surface.

FIG. 4F is a photo showing a P mapping result of cutting a specimen after a heat treatment and performing energy dispersive X-ray spectroscopy (EDS) on a grain boundary of a second layer that is present near a third layer in a cut surface.

FIG. 5 is a scanning electron microscope (SEM) photo of a specimen after a heat treatment in the same field of view as those in FIGS. 4A to 4F.

FIG. 6 is an enlarged photo showing a part of FIG. 5 in an enlarged manner.

FIG. 7 is a graph showing an element analysis result at a location represented with circles in FIG. 6.

### DESCRIPTION OF EMBODIMENTS

Hereinafter, the invention will be described in detail appropriately referring to drawings. The drawings used in the following description may show characteristic portions in an enlarged manner for the purpose of convenience for easy understanding of characteristics of the invention. Therefore, dimensional ratios and the like of the respective components shown in the drawings may differ from actual dimensional ratios and the like. Materials, dimensions, and the like in the following description are just exemplary examples, and the invention is not limited thereto and can be realized by being appropriately changed without changing the gist thereof.

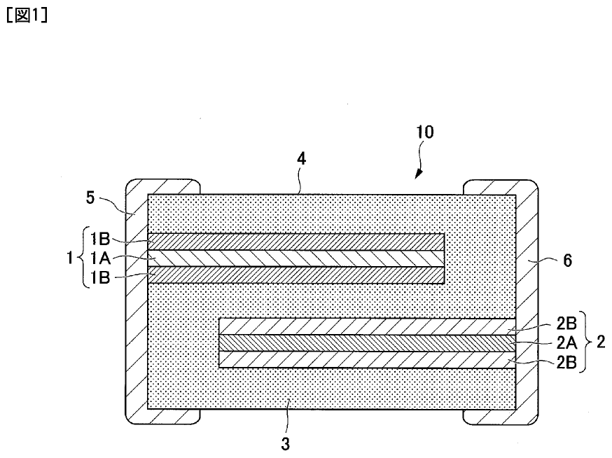

FIG. 1 is a schematic sectional view of an all-solid-state lithium ion secondary battery according to a first embodiment. An all-solid-state lithium ion secondary battery (hereinafter, also abbreviated as an “all-solid-state battery”) 10 shown in FIG. 1 includes a layered body 4, a first external terminal 5 (terminal electrode), and a second external terminal 6 (terminal electrode).

### (Layered Body)

The layered body 4 is adapted such that a plurality of (two layers in FIG. 1) electrode layers 1 (2) are laminated are laminated with a solid electrolyte layer 3 therebetween, a current collector layer 1A (2A) and an active material layer 1B (2B) being laminated in each of the electrode layers.

Either one of the two electrode layers 1 and 2 functions as a positive electrode layer, and the other one of them functions as a negative electrode layer. The positive and negative poles of the electrode layers change depending on which of polarities is connected to the terminal electrodes (the first external terminal 5 and the second external terminal 6).

Hereinafter, the electrode layer represented with a reference numeral 1 in FIG. 1 is assumed to be a positive electrode layer 1, and the electrode layer represented with a reference numeral 2 is assumed to be a negative electrode layer 2 for easy understanding.

The positive electrode layer 1 and the negative electrode layer 2 are alternately laminated with the solid electrolyte layer 3 therebetween. The all-solid-state battery 10 is charged and discharged through exchange of lithium ions between the positive electrode layer 1 and the negative electrode layer 2 via the solid electrolyte layer 3. Each of the numbers of the positive electrode layers 1 and the negative electrode layers 2 may be one or more.

### “Positive Electrode Layer and Negative Electrode Layer”

The positive electrode layer 1 has a positive electrode current collector layer 1A and a positive electrode active material layer 1B that contains a positive electrode active material. The negative electrode layer 2 has a negative electrode current collector layer 2A and a negative electrode active material layer 2B that contains a negative electrode active material.

The positive electrode current collector layer 1A and the negative electrode current collector layer 2A preferably have high electroconductivity. Therefore, it is preferable to use, for example, silver, palladium, gold, platinum, aluminum, copper, nickel, or the like for the positive electrode current collector layer 1A and the negative electrode current collector layer 2A. Among these substances, copper does not easily react with a positive electrode active material, a negative electrode active material, and a solid electrolyte. Therefore, it is possible to reduce an internal resistance of the all-solid-state battery 10 if copper is used for the positive electrode current collector layer 1A and the negative electrode current collector layer 2A. Note that substances that are included in the positive electrode current collector layer 1A and the negative electrode current collector layer 2A may be the same or different from each other.

The positive electrode current collector layer 1A and the negative electrode current collector layer 2A may contain a positive electrode active material and a negative electrode active material, respectively. The content ratio of the active materials contained in the respective current collector layers 1A and 2A is not particularly limited as long as the active materials function as current collectors. The content ratio of the active materials in the respective current collector layers 1A and 2A is preferably 10 to 30%, for example, in terms of volume ratio.

Adhesiveness between the positive electrode current collector layer 1A and the positive electrode active material layer 1B is enhanced by the positive electrode current collector layer 1A containing a positive electrode active material. Also, adhesiveness between the negative electrode current collector layer 2A and the negative electrode active material layer 2B is enhanced by the negative electrode current collector layer 2A containing a negative electrode active material.

The positive electrode active material layer 1B is formed on one surface or both surfaces of the positive electrode current collector layer 1A. In a case in which the positive electrode layer 1 is formed on an uppermost layer of the layered body 4 in a lamination direction of the positive electrode layers 1 and the negative electrode layers 2, for example, no facing negative electrode layer 2 is provided on the positive electrode layer 1 located in the uppermost layer. Therefore, it is only necessary for the positive electrode active material layer 1B to be provided on one surface of the positive electrode layer 1, which is located in the uppermost layer, on the lower side in the lamination direction.

The negative electrode active material layer 2B is formed on one surface or both surfaces of the negative electrode current collector layer 2A similarly to the positive electrode active material layer 1B. In a case in which the negative electrode layer 2 is formed in a lowermost layer of the layered body 4 in the lamination direction of the positive electrode layers 1 and the negative electrode layers 2, it is only necessary for the negative electrode active material layer 2B to be provided on one surface of the negative electrode layer 2, which is located in the lowermost layer, on the upper side in the lamination direction.

The positive electrode active material layer 1B contains a positive electrode active material that exchanges electrons and may contain an electroconductive aid and/or a binder and the like. The negative electrode active material layer 2B contains a negative electrode active material that exchanges electrons and may contain an electroconductive aid and/or a binder and the like. The positive electrode active material and the negative electrode active material may be adapted such that lithium ions can be efficiently inserted and desorbed.

For the positive electrode active material and the negative electrode active material, it is preferable to use, for example, a transition metal oxide or a transition metal composite oxide. Specifically, it is possible to use a compound represented as LiₐV_{b}Al_{c}Ti_{d}PₑO₁₂ (a, b, c, d, and e are numbers that satisfy 0.5≤a≤3.0, 1.20<b≤2.00, 0.01≤c<0.06, 0.01≤d<0.60, and 2.80≤e≤3.20, respectively), a lithium-manganese composite oxide Li₂MnₖMa₁₋ₖO₃ (0.8≤k≤1, Ma═Co, Ni), lithium cobaltate (LiCoO₂), lithium nickelate (LiNiO₂), lithium manganese spinel (LiMn₂O₄), a composite metal oxide represented as LiNiₓCo_{y}Mn_{z}O₂ (x+y+z=1, 0≤x≤1, 0≤y≤1, 0≤z≤1), a lithium vanadium compound (LiV₂O₅), olivine-type LiMbPO₄ (where Mb is one or more elements selected from the group consisting of Co, Ni, Mn, Fe, Mg, Nb, Ti, Al, and Zr), lithium vanadium phosphate (Li₃V₂(PO₄)₃ or LiVOPO₄), an Li excess solid solution positive electrode represented as Li₂MnO₃—LiMcO₂ (Mc═Mn, Co, Ni), lithium titanate (Li₄Ti₅O₁₂), a composite metal oxide represented as LiₛNiₜCoᵤAlᵥO₂ (0.9<s<1.3, 0.9<t+u+v<1.1), or the like.

The positive electrode active material layer 1B and/or the negative electrode active material layer 2B preferably contains a compound represented by a formula: LiₐV_{b}Al_{c}Ti_{d}PₑO₁₂ (a, b, c, d, and e are numbers that satisfy 0.5≤a≤3.0, 1.20<b≤2.00, 0.01≤c<0.06, 0.01≤d<0.60, and 2.80≤e≤3.20, respectively), in particular. In a case in which the positive electrode active material layer 1B and/or the negative electrode active material layer 2B contains the aforementioned compound, oxidation and reduction of Cu contained in the material that serve as the first external terminal 5 or the second external terminal 6 are promoted by oxidation and reduction of V that occurs during sintering for forming the first external terminal 5 and the second external terminal 6. As a result, the Cu-containing regions tend to be formed at the grain boundaries of the particles that form the positive electrode active material layer 1B and/or the negative electrode active material layer 2B that is present near the first external terminal 5 and/or the second external terminal 6.

The negative electrode active material and the positive electrode active material may be selected in accordance with an electrolyte used for the solid electrolyte layer 3, which will be described later.

In a case in which a compound represented as a formula: Li_{f}V_{g}AlₕTiᵢPⱼO₁₂ (f, g, h, i, and j are numbers that satisfy 0.5≤f≤3.0, 0.01≤g<1.00, 0.09<h≤0.30, 1.40<i≤2.00, 2.80≤j≤3.20, respectively) is used as an electrolyte of the solid electrolyte layer 3, for example, it is preferable to use one of or both compounds represented as LiVOPO₄ and LiaVₕAl_{c}Ti_{d}PₑO₁₂ (a, b, c, d, and e satisfy 0.5≤a≤3.0, 1.20<b≤2.00, 0.01≤c<0.06, 0.01≤d<0.60, and 2.80≤e≤3.20, respectively) as the positive electrode active material and the negative electrode active material. In this manner, bonding at an interface of the positive electrode active material layer 1B, the negative electrode active material layer 2B, and the solid electrolyte layer 3 becomes strong.

There is no clear distinction between the active materials that are included in the positive electrode active material layer 1B and the negative electrode active material layer 2B. It is possible to use a compound with a superior potential as a positive electrode active material and to use a compound with an inferior potential as a negative electrode active material by comparing the potentials of the two kinds of compound.

### “Solid Electrolyte Layer”

The electrolyte used for the solid electrolyte layer 3 is preferably a phosphate-based solid electrolyte. As the electrolyte, a material with low electron conductivity and high lithium ion conductivity is preferably used. Specifically, it is possible to use, as an electrolyte, at least one selected from the group consisting of a compound represented by a formula: Li_{f}V_{g}AlₕTiᵢPⱼO₁₂ (f, g, h, i, and j are numbers that satisfy 0.5≤f≤3.0, 0.01≤g<1.00, 0.09<h≤0.30, 1.40<i≤2.00, and 2.80≤j≤3.20, respectively), a Perovskite-type compound such as La_{0.5}Li_{0.5}TiO₃, a Lisicon-type compound such as Li₁₄Zn(GeO₄)₄, a garnet-type compound such as Li₇La₃Zr₂O₁₂, a Nasicon-type compound such as Li₁₃Al_{0.3}Ti_{1.7}(PO₄)₃ or Li₁₅Al_{0.5}Ge₁₅(PO₄)₃, a thiolisicon-type compound such as Li_{3.25}Ge_{0.25}P_{0.75}S₄ or Li₃PS₄, a glass compound such as Li₂S—P₂S₅ or Li₂O—V₂O₅—SiO₂, and a phosphoric acid compound such as Li₃PO₄, Li_{3.5}Si_{0.5}P_{0.5}O₄, or Li_{2.9}PO_{3.3}N_{0.46}.

The solid electrolyte layer 3 preferably contains the compound represented as the formula: LiN_{g}AlₕTiᵢPⱼO₁₂ (f, g, h, i, and j are numbers that satisfy 0.5≤f≤3.0, 0.01≤g<1.00, 0.09<h≤0.30, 1.40<i≤2.00, and 2.80≤j≤3.20, respectively), in particular, among the above compounds. In a case in which the solid electrolyte layer 3 contains the aforementioned compound, oxidation and reduction of Cu contained in a terminal material that serves as the first external terminal 5 or the second external terminal 6 are promoted by oxidation and reduction of Ti during sintering for forming the first external terminal 5 and the second external terminal 6. As a result, the Cu-containing regions are easily formed at the grain boundaries of the particles that form the solid electrolyte layer 3 that is present near the first external terminal 5 and/or the second external terminal 6.

### (Terminal Electrode)

The first external terminal 5 is formed such that the first external terminal 5 is in contact with a side surface of the layered body 4 from which an end surface of the positive electrode layer 1 is exposed. The positive electrode layer 1 is connected to the first external terminal 5. Also, the second external terminal 6 is formed in contact with a side surface of the layered body 4 from which an end surface of the negative electrode layer 2 is exposed. The negative electrode layer 2 is connected to the second external terminal 6. The second external terminal 6 is formed in contact with a side surface that is different from the side surface of the layered body 4 on which the first external terminal 5 is formed. The first external terminal 5 and the second external terminal 6 are electrically connected to the outside.

The first external terminal 5 and the second external terminal 6 contain Cu. Also, the first external terminal 5 and the second external terminal 6 preferably contain at least one selected from the group consisting of V, Fe, Ni, Co, Mn, and Ti in addition to Cu. In a case in which the first external terminal 5 and the second external terminal 6 contain these elements, oxidation and reduction of Cu contained in a terminal material that serves as the first external terminal 5 or the second external terminal 6 are promoted by oxidation and reduction of the aforementioned element that occurs during sintering for forming the first external terminal 5 and the second external terminal 6. As a result, the Cu-containing regions are easily formed at the grain boundaries of the particles that form the solid electrolyte layer 3, the positive electrode active material layer 1B, and/or the negative electrode active material layer 2B that is present near the first external terminal 5 and/or the second external terminal 6.

The amount of at least one selected from the group consisting of V, Fe, Ni, Co, Mn, and Ti contained in the first external terminal 5 and the second external terminal 6 is preferably 0.4 to 12.0% by mass, for example. If the amount of the aforementioned element is from 0.4 to 12.0% by mass, the effect of promoting the formation of the Cu-containing regions in the sintering for forming the first external terminal 5 and the second external terminal 6 is significantly achieved.

The first external terminal 5 and the second external terminal 6 may contain any of the aforementioned positive electrode active materials or the negative electrode active materials. In a case in which the first external terminal 5 contains a positive electrode active material, bonding at an interface between the first external terminal 5 and the positive electrode active material layer 1B becomes stronger since a difference in a change in volume of the first external terminal 5 and the positive electrode active material layer 1B becomes smaller during charge and discharge. Also, in a case in which the second external terminal 6 contains a negative electrode active material, bonding at an interface between the second external terminal 6 and the negative electrode active material layer 2B becomes stronger since a difference in a change in volume of the second external terminal 6 and the negative electrode active material layer 2B becomes smaller during charge and discharge.

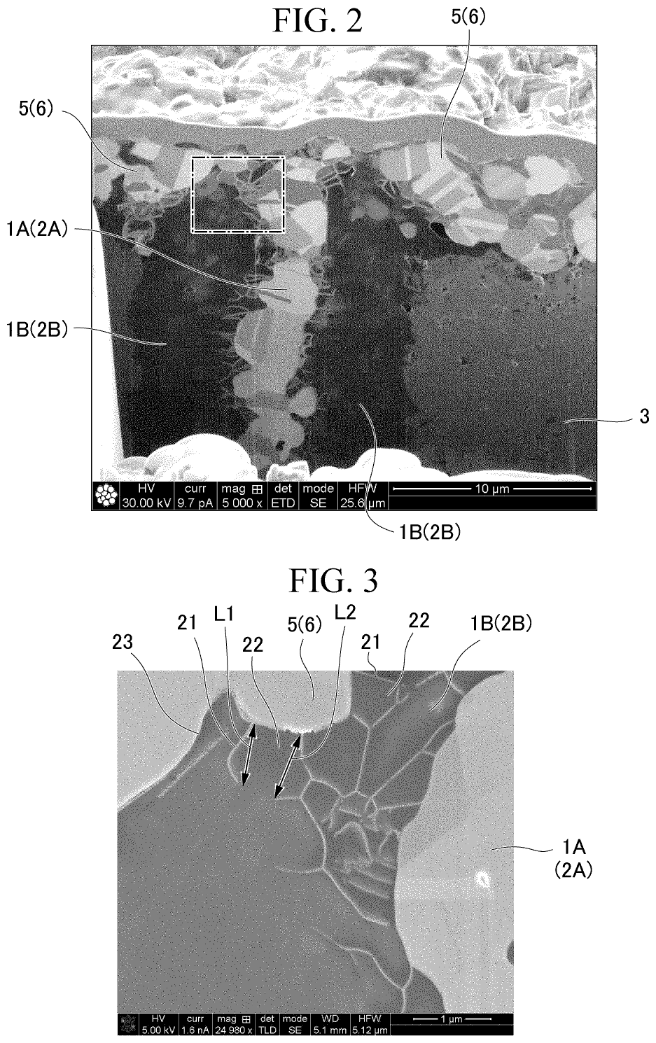

Next, the Cu-containing regions formed in the all-solid-state battery 10 according to the embodiment shown in FIG. 1 will be described with reference to FIGS. 2 and 3. FIG. 2 is a scanning electron microscope (SEM) photo of an example of the all-solid-state battery according to this disclosure and is a photo of an all-solid-state battery in Example 2, which will be described later. FIG. 2 is a photo capturing a section of a bonding portion between the terminal electrode 5 (6) of the all-solid-state battery 10 and the layered body 4 from which an end surface of the electrode layer 1 (2) is exposed. FIG. 3 is an enlarged photo showing a part of FIG. 2 in an enlarged manner and is an enlarged photo in the frame of the dashed line in FIG. 2. The reference numeral 1A (2A) represents the current collector layer, and the reference numeral 1B (2B) represents the active material layer in FIGS. 2 and 3.

In the all-solid-state battery 10 shown in FIGS. 2 and 3, Cu-containing regions 21 (portion in the form of white lines in FIG. 3) are formed at grain boundaries that are present near the terminal electrode 5 (6) among grain boundaries of particles 22 that form the active material layer 1B (2B) of the electrode layer 1 (2) and the solid electrolyte layer 3. The Cu-containing regions 21 are integrated with the terminal electrode 5 (6) and have an anchor effect with respect to the terminal electrode 5 (6).

“Near the terminal electrode” in the embodiment means a contact portion between the terminal electrode 5 (6) and the active material layer 1B (2B) or the solid electrolyte layer 3, which includes an active material or a solid electrolyte that is in contact with the terminal electrode 5 (6). That is, the present disclosure is for enhancing the bonding strength between the terminal electrode 5 (6) and the active material layer 1B (2B) or the solid electrolyte 3 by having portions (Cu-containing regions 21), at which the terminal electrode 5 (6) and the active material layer 1B (2B) or the solid electrolyte layer 3 are anchored to each other, at the bonding portion at which the terminal electrode 5 (6) and the active material or the solid electrolyte are bonded to each other.

The amount of Cu in the Cu-containing regions 21 is higher than that of the particles 22 that form the active material layer 1B (2B) and the solid electrolyte layer 3.

The amount of Cu in the Cu-containing regions 21 is preferably 50 to 100% by mass and is more preferably 90 to 99% by mass. The effect of enhancing the bonding strength between the layered body 4 and the terminal electrode 5 (6) due to the Cu-containing regions 21 is enhanced as the amount of Cu in the Cu-containing regions 21 increases.

In regard to the Cu-containing regions 21, the shortest distance between a border 23 of the active material layer 1B (2B) or the solid electrolyte layer 3 and the terminal electrode 5 (6) shown in FIGS. 2 and 3 and a Cu-containing region 21, which extends from the border 23 toward the side of the active material layer 1B (2B) or the solid electrolyte layer 3 and formed in a furthest location from the boundary is preferably 0.1 to 50 μm. Further, the aforementioned shortest distance between the border 23 and the Cu-containing region 21 is preferably 1 to 10 μm. If the aforementioned shortest distance is equal to or greater than 0.1 μm, the effect of enhancing the bonding strength between the layered body 4 and the terminal electrode 5 (6) due to the inclusion of the Cu-containing regions 21 is more significantly achieved. Therefore, it is possible to more effectively prevent the terminal electrode 5 (6) from peeling off from the layered body 4. Also, if the aforementioned shortest distance is equal to or less than 50 μm, it is possible to prevent an end surface on a side, on which the end surface is not exposed from the side surface of the layered body 4, among end surfaces of the electrode layer 1 (2) from being electrically connected to the terminal electrode 5 (6) and being short-circuited.

The shortest distance between the border 23 and the Cu-containing region 21 that extends from the border 23 toward the side of the active material layer 1B (2B) or the solid electrolyte layer 3 and formed in the furthest location from the boundary can be measured by observing the section of the bonding portion between the terminal electrode 5 (6) and the layered body 4 of the all-solid-state battery 10 using a scanning electron microscope (SEM) at a magnification of 5000-fold, for example.

Specifically, shortest distances L1, L2, . . . connecting both ends of the respective Cu-containing regions 21 that extend from the border 23 of the measurement region toward the side of the active material layer 1B (2B) or the solid electrolyte layer 3 are measured as shown in FIG. 3. Then, the longest distance among the measured shortest distances L1, L2, . . . is assumed to be the “shortest distance between the border 23 and the Cu-containing region 21 that extends from the border 23 toward the side of the active material layer 1B (2B) or the solid electrolyte layer 3 and that is located at the furthest position”.

The length of the border 23 between the active material layer 1B (2B) or the solid electrolyte layer 3 and the terminal electrode 5 (6) that is required to measure the aforementioned shortest distance is set to be equal to or greater than 200 μm in order to obtain sufficient measurement accuracy.

Also, in a case in which the terminal electrode 5 (6) contains an active material, Cu is preferably contained at the grain boundaries of the particles that form the active material in the terminal electrode 5 (6). In this case, bonding at an interface between the terminal electrode 5 (6) and the active material layer 1B (2B) becomes yet stronger.

Also, an area of the grain boundaries that correspond to the Cu-containing regions 21 is preferably equal to or greater than 50% and is more preferably equal to or greater than 80% with respect to the area of the grain boundaries of the particles that are present at the interface between the layered body 4 and the terminal electrode 5(6). The anchor effect of the Cu-containing regions 21 with respect to the terminal electrode 5 (6) increases, and the effect of enhancing the bonding strength between the layered body 4 and the terminal electrode 5 (6) due to the Cu-containing region 21 is enhanced as the proportion of the area of the Cu-containing regions 21 in the grain boundaries of the particles that are present at the interface between the layered body 4 and the terminal electrode 5 (6) increases.

The proportion of the Cu-containing regions 21 with respect to the area of the grain boundaries of the particles that are present at the interface between the layered body 4 and the terminal electrode 5 (6) can be calculated by the following method.

The section of the bonding portion between the terminal electrode 5 (6) and the layered body 4 of the all-solid-state battery 10 is observed using a scanning electron microscope (SEM) at a magnification of 5000 folds, for example. It is possible to clearly distinguish, from the obtained SEM photo, the interface between the layered body 4 and the terminal electrode 5 (6), the grain boundaries of the particles that are present at the interface, and whether or not the grain boundaries are the Cu-containing regions 21. Further, it is possible to confirm whether or not the grain boundaries are the Cu-containing regions 21 using a Cu distribution obtained by performing energy dispersive X-ray spectroscopy (EDS) on the grain boundaries of the particles that are present at the interface between the layered body 4 and the terminal electrode 5 (6).

In the embodiment, the sum of lengths at the grain boundaries of the particles that are present at the interface between the layered body 4 and the terminal electrode 5 (6) calculated from the SEM photo is regarded as an area of the grain boundaries. Note that the number of particles measured for calculating the aforementioned area of the grain boundaries (the sum of the lengths of the grain boundaries) is preferably equal to or greater than 100, and for calculating the aforementioned area of the grain boundaries more accurately, the number of particles is preferably equal to or greater than 300. Also, the sum of the lengths of the grain boundaries that are the Cu-containing regions 21 calculated from the SEM photo in the aforementioned area of the grain boundaries (the sum of the lengths of the grain boundaries) is regarded as an area of the Cu-containing regions 21. Using the thus obtained area of the grain boundaries and the area of the Cu-containing regions 21, the proportion of the area of the Cu-containing regions 21 with respect to the aforementioned area of the grain boundaries is calculated.

In addition, the area corresponding to the Cu-containing regions 21 in the interface between the layered body 4 and the terminal electrode 5 (6) is preferably equal to or greater than 50%. The effect of enhancing the bonding strength between the layered body 4 and the terminal electrode 5 (6) due to the Cu-containing regions 21 is further enhanced when the proportion of the Cu-containing regions 21 in the interface between the layered body 4 and the terminal electrode 5 (6) is higher.

(Method for Manufacturing All-solid-state Battery)

Next, a method for manufacturing the all-solid-state battery 10 will be described.

The method for manufacturing the all-solid-state battery 10 according to the embodiment includes a lamination process of laminating the plurality of electrode layers 1 (2) in which the current collector layer 1A (2A) and the active material layer 1B (2B) are laminated with a solid electrolyte layer 3 therebetween, thereby forming a layered sheet, and a sintering process of forming and sintering a terminal electrode layer on a side surface of the layered sheet or a side surface of the layered body 4 that is obtained by sintering the layered sheet, thereby forming the terminal electrode 5 (6).

### (Lamination Process)

As a method of forming the layered body 4, a simultaneous burning method may be used, or a sequential burning method may be used.

The simultaneous burning method is a method of laminating materials that form the respective layers and producing the layered body through collective burning. The sequential burning method is a method of producing the respective layers in order and performing a burning process every time each layer is produced. It is possible to form the layered body 4 in a smaller number of operation processes in a case of using the simultaneous burning method than in a case of using the sequential burning method. Also, the obtained layered body 4 becomes finer in the case of using the simultaneous burning method than in the case of using the sequential burning method.

Hereinafter, an exemplary example of a case in which the layered body 4 is manufactured using the simultaneous burning method will be described. In addition, an exemplary example of a case in which the burning for forming the layered body 4 is performed at the same time as burning for forming the terminal electrode 5 (6) will be described in the embodiment.

The simultaneous burning method has a process of producing pastes of the respective materials that are included in the layered body 4, a process of producing green sheets using the pastes, and a process of obtaining a layered sheet by laminating the green sheets and simultaneously burning the layered sheet.

First, the respective materials for the positive electrode current collector layer 1A, the positive electrode active material layer 1B, the solid electrolyte 3, the negative electrode active material layer 2B, and the negative electrode current collector layer 2A that are included in the layered body 4 are prepared in the form of pastes.

A method of preparing the respective materials in the form of pastes is not particularly limited. For example, pastes may be obtained by mixing powder of the respective materials into vehicles. Here, the vehicles collectively refer to mediums in a liquid phase. The vehicles contain solvents and binders.

The paste for the positive electrode current collector layer 1A, the paste for the positive electrode active material layer 1B, the paste for the solid electrolyte 3, the paste for the negative electrode active material layer 2B, and the paste for the negative electrode current collector layer 2A are produced by such a method.

Then, green sheets are produced. The green sheets are obtained by applying the produced pastes to base materials such as polyethylene terephthalate (PET) films or the like, drying the pastes as needed, and peeling off the base materials.

A method of applying the pastes is not particularly limited. For example, a known method such as screen printing, application, transferring, or a doctor blade can be employed.

Next, the respectively produced green sheets are stacked in accordance with a desired order and the number of layers to be laminated, thereby obtaining a layered sheet. When the green sheets are laminated, alignment, cutting, or the like is performed as needed.

The layered sheet may be produced using a method of producing a positive electrode active material layer unit and a negative electrode active material layer unit, which will be described later and laminating the positive electrode active material layer unit and the negative electrode active material layer unit.

First, the paste for the solid electrolyte 3 is applied to a base material such as a PET film by a doctor blade method and is then dried, thereby forming the solid electrolyte layer 3 in the form of a sheet. Next, the paste for the positive electrode active material layer 1B is printed on the solid electrolyte 3 by screen printing and is then dried, thereby forming the positive electrode active material layer 1B. Then, the paste for the positive electrode current collector layer 1A is printed on the positive electrode active material layer 1B by screen printing and is then dried, thereby forming the positive electrode current collector layer 1A. Further, the paste for the positive electrode active material layer 1B is printed on the positive electrode current collector layer 1A by screen printing and is then dried, thereby forming the positive electrode active material layer 1B.

Thereafter, the PET film is peeled off, thereby obtaining the positive electrode active material layer unit. The positive electrode active material layer unit is a layered sheet in which the solid electrolyte layer 3, the positive electrode active material layer 1B, the positive electrode current collector layer 1A, and the positive electrode active material layer 1B are laminated in this order.

The negative electrode active material layer unit is produced in a similar procedure. The negative electrode active material layer unit is a layered sheet in which the solid electrolyte layer 3, the negative electrode active material layer 2B, the negative electrode current collector layer 2A, and the negative electrode active material layer 2B are laminated in this order.

Next, one positive electrode active material layer unit and one negative electrode active material layer unit are laminated. At this time, the positive electrode active material layer unit and the negative electrode active material layer unit are laminated such that the solid electrolyte layer 3 in the positive electrode active material layer unit is brought into contact with the negative electrode active material layer 2B in the negative electrode active material layer unit or the positive electrode active material layer 1B in the positive electrode active material layer unit is brought into contact with the solid electrolyte layer 3 in the negative electrode active material layer unit. In this manner, the layered sheet in which the positive electrode active material layer 1B, the positive electrode current collector layer 1A, the positive electrode active material layer 1B, the solid electrolyte layer 3, the negative electrode active material layer 2B, the negative electrode current collector layer 2A, the negative electrode active material layer 2B, and the solid electrolyte layer 3 are laminated in this order is obtained.

Note that when the positive electrode active material layer unit and the negative electrode active material layer unit are laminated, the respective units are piled up in a deviating manner such that the positive electrode current collector layer 1A in the positive electrode active material layer unit extends only toward one end surface and the negative electrode current collector layer 2A in the negative electrode active material layer unit extends toward the other surface. Thereafter, the sheet for the solid electrolyte layer 3 with a predetermined thickness is further piled up on the surface on a side on which the solid electrolyte layer 3 is not present on the surface although the units are piled up thereon, thereby obtaining a layered sheet.

Next, the layered sheets produced by any of the aforementioned methods are collectively pressure-bonded to each other.

The pressure-bonding is preferably performed while the layered sheets are heated. The heating temperature at the time of the pressure-bonding is set to 40 to 95° C., for example.

### (Sintering Process)

In the sintering process, a terminal electrode layer that serves as the terminal electrode 5 (6) is formed and sintered such that the terminal electrode layer is in contact with a side surface of the layered sheet from which the end surface of the current collector layer 1A (2A) is exposed, thereby forming the terminal electrode 5 (6).

The terminal electrode layers that serve as the first external terminal 5 and the second external terminal 6 can be formed by a known method. Specifically, it is possible to use, for example, a sputtering method, a spray coating method, a dipping method, or the like. The first external terminal 5 and the second external terminal 6 are formed only at predetermined portions of the surface of the layered sheet, from which the positive electrode current collector layer 1A and the negative electrode current collector layer 2A are exposed. Therefore, the first external terminal 5 and the second external terminal 6 are formed by applying masking using, for example, a tape to a region of the surface of the layered sheet on which the first external terminal 5 and the second external terminal 6 are not formed when the first external terminal 5 and the second external terminal 6 are formed.

Next, a layered sheet with the terminal electrode layer formed on the side surface thereof is sintered. The aforementioned layered sheet is heated to 500° C. to 750° C. in a nitrogen, hydrogen, and water vapor atmosphere, for example, thereby performing debinding. Thereafter, a heat treatment of raising the temperature to a room temperature to 400° C. in an atmosphere of an oxygen partial pressure of 1×10⁻⁵ to 2×10⁻¹¹ atm and heating the layered sheet at a temperature of 400 to 950° C. in an atmosphere of an oxygen partial pressure of 1×10⁻¹¹ to 1×10⁻²¹ atm is performed in the sintering process. Note that the oxygen partial pressure is a numerical value measured by an oxygen concentration meter at a sensor temperature of 700° C.

In a case in which such a heat treatment is performed, Cu contained in the terminal electrode layer that serves as the terminal electrode 5 (6) is dispersed as an oxide (Cu₂O) to the grain boundaries of the active material layer 1B (2B) and the solid electrolyte 3 in the process of raising the temperature from room temperature to 400° C. The oxygen partial pressure in the process of raising the temperature from room temperature to 400° C. is preferably 1×10⁻⁵ to 2×10⁻¹¹ atm and is further preferably 1×10⁻⁷ to 5×10⁻¹⁰ atm in order to promote dispersion of Cu₂O.

Cu₂O dispersed to the grain boundaries in the process of raising the temperature from room temperature to 400° C. is reduced to metal Cu in the process of heating the layered body at the temperature of 400 to 950° C. The oxygen partial pressure when the layered body is heated at the temperature of 400 to 950° C. is preferably 1×10⁻¹¹ to 1×10⁻²¹ atm and is further preferably 1×10⁻¹⁴ to 5×10⁻²⁰ atm in order to promote reduction of Cu₂O.

It is possible to control a range of the grain boundaries at which the Cu-containing regions 21 are formed by controlling a retention time during which the heating at the temperature of 400 to 950° C. is performed in the aforementioned heat treatment. That is, the range of the grain boundaries at which the Cu-containing regions 21 are formed becomes narrower as the retention time in the aforementioned temperature range is shorter, and the range of the grain boundaries at which the Cu-containing regions 21 are formed becomes wider as the retention time in the aforementioned temperature range is longer.

Specifically, it is possible to form the Cu-containing regions 21 that extend from the border 23 of the active material layer 1B (2B) or the solid electrolyte layer 3 and the terminal electrode 5 (6) to a location of 0.1 to 50 μm at the shortest distance on the side of the active material layer 1B (2B) or the solid electrolyte layer 3 at the grain boundaries of the particles that form the active material layer 1B (2B) and the solid electrolyte layer 3 by setting the retention time within the aforementioned temperature range to 0.4 to 5 hours. Also, it is possible to form the Cu-containing regions 21 that extend from the aforementioned border 23 to the location of 1 to 10 μm at the shortest distance on the side of the active material layer 1B (2B) or the solid electrolyte layer 3 at the aforementioned grain boundaries by setting the retention time in the aforementioned temperature range to 1 to 3 hours.

In the embodiment, the Cu-containing regions 21 are formed at the grain boundaries that are present near the terminal electrode 5 (6) among the grain boundaries of the particles that form the active material layer 1B (2B) and the solid electrolyte layer 3 at the same time as the formation of the layered body 4 and the terminal electrode 5 (6) by performing the heat treatment in which the temperature and the oxygen partial pressure are set to be within the aforementioned ranges.

Note that although the terminal electrode layers are formed and sintered on the side surfaces of the layered sheet and the terminal electrodes 5 (6) are formed at the same time as the layered body 4 in the aforementioned manufacturing method, the terminal electrode layers that serve as the first external terminal 5 and the second external terminal 6 may be formed and sintered on the side surfaces of the layered body 4 obtained by sintering the layered sheet from which the end surfaces of the current collector layer 1A (2A) are exposed, thereby forming the terminal electrodes 5(6). In this case, burning of the layered sheet for forming the layered body 4 is performed before the terminal electrode layers are formed separately from burning for forming the terminal electrodes 5 (6). The debinding of the layered sheet is performed by heating the layered sheet to 500° C. to 750° C. in a nitrogen, hydrogen, and water vapor atmosphere, for example. The burning of the layered sheet is preferably performed by heating the layered sheet to 600° C. to 1000° C. in a nitrogen atmosphere, for example. The burning time is preferably set to 0.1 to 3 hours, for example.

In the thus obtained all-solid-state battery 10, the terminal electrode 5 (6) contains Cu, and the Cu-containing regions 21 are formed at the grain boundaries that are present near the terminal electrode 5 (6) among the grain boundaries of the particles that form the active material layer 1B (2B) and the solid electrolyte layer 3. Therefore, the all-solid-state battery 10 in which the layered body 4 including the active material layer 1B (2B) and the solid electrolyte layer 3 and the terminal electrode 5 (6) are bonded with satisfactory bonding strength is achieved due to the anchor effect of the Cu-containing region 21 with respect to the terminal electrode 5 (6). As a result, it is possible to prevent the peeling of the layered body 4 and the terminal electrode 5 (6) due to impact from the outside. Also, it is possible to prevent the peeling of the layered body 4 and the terminal electrode 5 (6) caused by a change in volume of the active material layer 1B (2B) that accompanies charging and discharging and to obtain satisfactory cycling characteristics.

In the sintered body of the layered sheet, the relative density of the electrode layer and the solid electrolyte layer may be equal to or greater than 80%. Dispersion paths of movable ions in a crystal are easily connected to each other, and ion conductivity is enhanced as the relative density increases.

Although the embodiments of the invention have been described above in detail with reference to the drawings, the respective configurations, the combinations thereof, and the like in the respective embodiments are just examples, and additions, omissions, replacements, and other changes of configurations can be made without departing from the gist of the invention.

### EXAMPLES

### Examples 1 to 18 and Comparative Example 1

A layered sheet in which the solid electrolyte layer 3, the positive electrode active material layer 1B, the positive electrode current collector layer 1A, the positive electrode active material layer 1B, the solid electrolyte layer 3, the negative electrode active material layer 2B, the negative electrode current collector layer 2A, the negative electrode active material layer 2B, and the solid electrolyte layer 3 were laminated in this order was produced.

Compositions of the positive electrode active material layer 1B, the solid electrolyte layer 3, and the negative electrode active material layer 2B are shown in Tables 1 to 3.

Cu was used for the positive electrode current collector layer 1A and the negative electrode current collector layer 2A.

Next, a material in the form of a paste that served as the first external terminal 5 was applied to a side surface of the layered sheet from which an end surface of the positive electrode current collector layer 1A was exposed, thereby forming a terminal electrode layer. Also, a material in the form of a paste that served as the second external terminal 6 was applied to a side surface of the layered sheet from which an end surface of the negative electrode current collector layer 2A was exposed, thereby forming a terminal electrode layer.

In Examples 2 and 3, Cu containing 2.0% by mass of the terminal electrode-containing material shown in Tables 1 to 3 was used as the material for the terminal electrode 5 (6). In Examples 1 and 4 to 18 and Comparative Example 1, Cu was used as a material for the terminal electrode 5 (6).

Next, the layered sheet with the terminal electrode layers formed in contact with the side surfaces was subject to a heat treatment and was sintered under the following conditions to form the terminal electrode 5 (6) at the same time as the layered body 4, thereby obtaining an all-solid-state battery.

In Examples 1 to 18, a treatment of raising the temperature from room temperature to 400° C. in an atmosphere of an oxygen partial pressure of 2×10⁻¹⁰ atm, further raising the temperature to 400 to 850° C. in an atmosphere of an oxygen partial pressure of 5×10⁻¹⁵ atm, and performing heating in retention times shown in Tables 1 to 3 in an atmosphere of an oxygen partial pressure of 5×10⁻¹⁵ atm at a temperature of 850° C. was performed as a heat treatment. Note that the oxygen partial pressure was a numerical value measured using an oxygen concentration meter at a sensor temperature of 700° C.

In Comparative Example 1, a treatment of raising the temperature from room temperature to 850° C. in an atmosphere of an oxygen partial pressure of 2×10⁻¹⁰ atm and performing heating in a retention time shown in Table 3 in an atmosphere of an oxygen partial pressure of 2×10⁻¹⁰ atm at a temperature of 850° C. was performed as a heat treatment.

TABLE 1

| | | Cu- | Current collector | Shortest | | Retention time at | | | | | | | | |
|---|---|---|---|---|---|---|---|---|---|---|---|---|---|---|
| | | containing | layer-containing | distance | | burning temperature | | Composition (% by atom) | | | | | | Bonding |
| | | regions | material | from border | | (850° C.) | | I.i | V | Al | Ti | P | O | strength |
| Example | Positive electrode | Present | None | 1 | μm | 1 | hour | 2.55 | 1.50 | 0.05 | 0.45 | 3.00 | 12 | A |
| 1 | active material layer | | | | | | | | | | | | | |
| | Solid electrolyte | | | | | | | 1.00 | 0.05 | 0.12 | 1.70 | 3.00 | 12 | |
| | layer | | | | | | | | | | | | | |
| | Negative electrode | | | | | | | 2.55 | 1.50 | 0.05 | 0.45 | 3.00 | 12 | |
| | active material layer | | | | | | | | | | | | | |
| Example | Positive electrode | Present | LiVOPO₄ | 1 | μm | 1 | hour | 0.40 | 1.80 | 0.10 | 1.10 | 2.70 | 12 | A |
| 2 | active material layer | | | | | | | | | | | | | |
| | Solid electrolyte | | | | | | | 0.45 | 0.30 | 0.15 | 2.10 | 2.75 | 12 | |
| | layer | | | | | | | | | | | | | |
| | Negative electrode | | | | | | | 0.40 | 1.80 | 0.10 | 1.10 | 2.70 | 12 | |
| | active material layer | | | | | | | | | | | | | |
| Example | Positive electrode | Present | LiTi₂(PO₄)₃ | 1 | μm | 1 | hour | 2.90 | 2.00 | 0.00 | 0.00 | 3.00 | 12 | A |
| 3 | active material layer | | | | | | | | | | | | | |
| | Solid electrolyte | | | | | | | 1.00 | 0.05 | 0.12 | 1.70 | 3.00 | 12 | |
| | layer | | | | | | | | | | | | | |
| | Negative electrode | | | | | | | 2.90 | 2.00 | 0.00 | 0.00 | 3.00 | 12 | |
| | active material layer | | | | | | | | | | | | | |
| Example | Positive electrode | Present | None | 0.1 | μm | 0.4 | hours | 2.90 | 2.00 | 0.00 | 0.00 | 3.00 | 12 | A |
| 4 | active material layer | | | | | | | | | | | | | |
| | Solid electrolyte | | | | | | | 1.00 | 0.05 | 0.12 | 1.70 | 3.00 | 12 | |
| | layer | | | | | | | | | | | | | |
| | Negative electrode | | | | | | | 2.90 | 2.00 | 0.00 | 0.00 | 3.00 | 12 | |
| | active material layer | | | | | | | | | | | | | |
| Example | Positive electrode | Present | None | 10 | μm | 3 | hours | 2.90 | 2.00 | 0.00 | 0.00 | 3.00 | 12 | A |
| 5 | active material layer | | | | | | | | | | | | | |
| | Solid electrolyte | | | | | | | 1.00 | 0.05 | 0.12 | 1.70 | 3.00 | 12 | |
| | layer | | | | | | | | | | | | | |
| | Negative electrode | | | | | | | 2.90 | 2.00 | 0.00 | 0.00 | 3.00 | 12 | |
| | active material layer | | | | | | | | | | | | | |
| Example | Positive electrode | Present | None | 50 | μm | 5 | hours | 2.90 | 2.00 | 0.00 | 0.00 | 3.00 | 12 | A |
| 6 | active material layer | | | | | | | | | | | | | |
| | Solid electrolyte | | | | | | | 1.00 | 0.05 | 0.12 | 1.70 | 3.00 | 12 | |
| | layer | | | | | | | | | | | | | |
| | Negative electrode | | | | | | | 2.90 | 2.00 | 0.00 | 0.00 | 3.00 | 12 | |
| | active material layer | | | | | | | | | | | | | |
| Example | Positive electrode | Present | None | 1 | μm | 1 | hour | 0.70 | 1.70 | 0.05 | 0.55 | 3.15 | 12 | A |

| | | | | | | | |
|---|---|---|---|---|---|---|---|
| 7 | active material layer | | | | | | |
| | Solid electrolyte | 0.50 | 0.05 | 0.20 | 2.00 | 2.80 | 12 |
| | layer | | | | | | |
| | Negative electrode | 0.70 | 1.70 | 0.05 | 0.55 | 3.15 | 12 |
| | active material layer | | | | | | |

TABLE 2

| | | Cu- | Current collector | Shortest | | Retention time at | | | | | | | | |
|---|---|---|---|---|---|---|---|---|---|---|---|---|---|---|
| | | containing | layer-containing | distance | | burning temperature | | Composition (% by atom) | | | | | | Bonding |
| | | regions | material | from border | | (850° C.) | | I.i | V | Al | Ti | P | O | strength |
| Example | Positive electrode | Present | None | 1 | μm | 1 | hour | 0.50 | 1.85 | 0.04 | 0.55 | 3.10 | 12 | A |
| 8 | active material layer | | | | | | | | | | | | | |
| | Solid electrolyte | | | | | | | 1.00 | 0.05 | 0.12 | 1.70 | 3.00 | 12 | |
| | layer | | | | | | | | | | | | | |
| | Negative electrode | | | | | | | 0.50 | 1.85 | 0.04 | 0.55 | 3.10 | 12 | |
| | active material layer | | | | | | | | | | | | | |
| Example | Positive electrode | Present | None | 1 | μm | 1 | hour | 1.70 | 2.00 | 0.05 | 0.40 | 2.90 | 12 | A |
| 9 | active material layer | | | | | | | | | | | | | |
| | Solid electrolyte | | | | | | | 1.00 | 0.05 | 0.12 | 1.70 | 3.00 | 12 | |
| | layer | | | | | | | | | | | | | |
| | Negative electrode | | | | | | | 1.70 | 2.00 | 0.05 | 0.40 | 2.90 | 12 | |
| | active material layer | | | | | | | | | | | | | |
| Example | Positive electrode | Present | None | 1 | μm | 1 | hour | 2.20 | 1.60 | 0.01 | 0.50 | 3.00 | 12 | A |
| 10 | active material layer | | | | | | | | | | | | | |
| | Solid electrolyte | | | | | | | 1.00 | 0.05 | 0.12 | 1.70 | 3.00 | 12 | |
| | layer | | | | | | | | | | | | | |
| | Negative electrode | | | | | | | 2.20 | 1.60 | 0.01 | 0.50 | 3.00 | 12 | |
| | active material layer | | | | | | | | | | | | | |
| Example | Positive electrode | Present | None | 1 | μm | 1 | hour | 2.60 | 1.90 | 0.04 | 0.01 | 3.10 | 12 | A |
| 11 | active material layer | | | | | | | | | | | | | |
| | Solid electrolyte | | | | | | | 1.00 | 0.05 | 0.12 | 1.70 | 3.00 | 12 | |
| | layer | | | | | | | | | | | | | |
| | Negative electrode | | | | | | | 2.60 | 1.90 | 0.04 | 0.01 | 3.10 | 12 | |
| | active material layer | | | | | | | | | | | | | |
| Example | Positive electrode | Present | None | 1 | μm | 1 | hour | 2.40 | 1.80 | 0.05 | 0.50 | 2.80 | 12 | A |
| 12 | active material layer | | | | | | | | | | | | | |
| | Solid electrolyte | | | | | | | 1.00 | 0.05 | 0.12 | 1.70 | 3.00 | 12 | |
| | layer | | | | | | | | | | | | | |
| | Negative electrode | | | | | | | 2.40 | 1.80 | 0.05 | 0.50 | 2.80 | 12 | |
| | active material layer | | | | | | | | | | | | | |
| Example | Positive electrode | Present | None | 1 | μm | 1 | hour | 2.10 | 1.40 | 0.04 | 0.40 | 3.20 | 12 | A |
| 13 | active material layer | | | | | | | | | | | | | |
| | Solid electrolyte | | | | | | | 1.00 | 0.05 | 0.12 | 1.70 | 3.00 | 12 | |
| | layer | | | | | | | | | | | | | |
| | Negative electrode | | | | | | | 2.10 | 1.40 | 0.04 | 0.40 | 3.20 | 12 | |
| | active material layer | | | | | | | | | | | | | |
| Example | Positive electrode | Present | None | 1 | μm | 1 | hour | 2.55 | 1.50 | 0.05 | 0.45 | 3.00 | 12 | A |

| | | | | | | | |
|---|---|---|---|---|---|---|---|
| 14 | active material layer | | | | | | |
| | Solid electrolyte | 0.50 | 0.05 | 0.12 | 1.90 | 3.00 | 12 |
| | layer | | | | | | |
| | Negative electrode | 2.55 | 1.50 | 0.05 | 0.45 | 3.00 | 12 |
| | active material layer | | | | | | |

TABLE 3

| | | Cu- | Current collector | Shortest | | Retention time at | | | | | | | | |
|---|---|---|---|---|---|---|---|---|---|---|---|---|---|---|
| | | containing | layer-containing | distance | | burning temperature | | Composition (% by atom) | | | | | | Bonding |
| | | regions | material | from border | | (850° C.) | | I.i | V | Al | Ti | P | O | strength |
| Example | Positive electrode | Present | None | 1 | μm | 1 | hour | 2.55 | 1.50 | 0.05 | 0.45 | 3.00 | 12 | A |
| 15 | active material layer | | | | | | | | | | | | | |
| | Solid electrolyte | | | | | | | 1.00 | 0.95 | 0.10 | 1.40 | 2.90 | 12 | |
| | layer | | | | | | | | | | | | | |
| | Negative electrode | | | | | | | 2.55 | 1.50 | 0.05 | 0.45 | 3.00 | 12 | |
| | active material layer | | | | | | | | | | | | | |
| Example | Positive electrode | Present | None | 1 | μm | 1 | hour | 2.55 | 1.50 | 0.05 | 0.45 | 3.00 | 12 | A |
| 16 | active material layer | | | | | | | | | | | | | |
| | Solid electrolyte | | | | | | | 1.00 | 0.30 | 0.12 | 1.90 | 2.80 | 12 | |
| | layer | | | | | | | | | | | | | |
| | Negative electrode | | | | | | | 2.55 | 1.50 | 0.05 | 0.45 | 3.00 | 12 | |
| | active material layer | | | | | | | | | | | | | |
| Example | Positive electrode | Present | None | 1 | μm | 1 | hour | 2.55 | 1.50 | 0.05 | 0.45 | 3.00 | 12 | A |
| 17 | active material layer | | | | | | | | | | | | | |
| | Solid electrolyte | | | | | | | 1.00 | 0.05 | 0.12 | 1.60 | 3.20 | 12 | |
| | layer | | | | | | | | | | | | | |
| | Negative electrode | | | | | | | 2.55 | 1.50 | 0.05 | 0.45 | 3.00 | 12 | |
| | active material layer | | | | | | | | | | | | | |
| Example | Positive electrode | Present | None | 1 | μm | 1 | hour | 2.55 | 1.50 | 0.05 | 0.45 | 3.00 | 12 | A |
| 18 | active material layer | | | | | | | | | | | | | |
| | Solid electrolyte | | | | | | | 1.00 | 0.05 | 0.12 | 1.70 | 3.00 | 12 | |
| | layer | | | | | | | | | | | | | |
| | Negative electrode | | | | | | | 2.90 | 2.00 | 0.00 | 0.00 | 3.00 | 12 | |
| | active material layer | | | | | | | | | | | | | |
| Com- | Positive electrode | None | None | | | 1 | hour | 2.90 | 2.00 | 0.00 | 0.00 | 3.00 | 12 | B |

| | | | | | | | |
|---|---|---|---|---|---|---|---|
| parative | active material layer | | | | | | |
| Example | Solid electrolyte | 1.00 | 0.05 | 0.12 | 1.70 | 3.00 | 12 |
| 1 | layer | | | | | | |
| | Negative electrode | 2.90 | 2.00 | 0.00 | 0.00 | 3.00 | 12 |
| | active material layer | | | | | | |

For all-solid-state batteries in Examples 1 to 18 and Comparative Example 1, whether or not Cu-containing regions were formed at grain boundaries that form the active material layer and the solid electrolyte layer that are present near the terminal electrode was examined by the aforementioned method. The results are shown in Tables 1 to 3.

Also, the shortest distance between the border of the active material layer or the solid electrolyte layer and the terminal electrode and the Cu-containing region that extended from the border toward the side of the active material layer or the solid electrolyte layer and that was formed at the furthest location was examined by the aforementioned method. The results are shown in Tables 1 to 3.

Also, for the all-solid-state batteries in Examples 1 to 18 and Comparative Example 1, bonding strength between the layered body 4 and the terminal electrode 5 (6) was examined by the following method. The results are shown in Tables 1 to 3.

### “Bonding Strength Test”

Lead lines were soldered to the centers of outer surfaces of the terminal electrodes 5 and 6 such that the lead lines were substantially vertical to the surfaces of the terminal electrodes 5 and 6. Then, a tensile test of pulling the lead lines in a direction in which the terminal electrode 5 and the terminal electrode 6 were separated from each other was conducted using a load cell tester, and evaluation was made in accordance with the following criteria.

A: The layered body 4 was broken before peeling of the bonding portion between the layered body 4 and the terminal electrode 5 (6).
B: The bonding portion between the layered body 4 and the terminal electrode 5 (6) peeled before the layered body 4 was broken.

As shown in Tables 1 to 3, Cu-containing regions were formed at the grain boundaries that were present near the terminal electrode in the all-solid-state batteries in Examples 1 to 18. All the results of the bonding strength test conducted on the all-solid-state batteries in Examples 1 to 18 were A, and satisfactory bonding strength was achieved between the layered body 4 and the terminal electrode 5 (6).

Meanwhile, no Cu-containing region was formed in Comparative Example 1. This was because Cu in the end electrode layers oxidized and dispersed when the temperature was raised from room temperature to 400° C. was not reduced to metal Cu since the burning was performed in the atmosphere in which the oxygen partial pressure was 2×10⁻¹⁰ atm that was higher than that in Example 1 at 400 to 850° C. in Comparative Example 1.

In Comparative Example 1 in which no Cu-containing region was formed, the result of the bonding strength test was B, and bonding strength between the layered body 4 and the terminal electrode 5 (6) was insufficient.

### Experiment Example

A paste was applied to a base material made of a PET film by a doctor blade method and was then dried, thereby forming a first layer in the form of a sheet with a thickness of 20 μm and with the composition that was the same as that of the solid electrolyte layer in Example 2 shown in Table 1. Next, a paste was printed on the first layer by screen printing and was then dried, thereby forming a second layer with a thickness of 4 μm and with the composition that was the same as those of the positive electrode active material layer and the negative electrode active material layer in Example 2 shown in Table 1. Then, a paste was printed on the second layer by screen printing and was then dried, thereby forming a third layer with a thickness of 4 μm that was made of Cu containing 2.0% by mass of LiVOPO₄. Thereafter, the base material was peeled off, thereby producing a unit including the first layer, the second layer, and the third layer.

Also, fifteen first layers were formed, and all the first layers were laminated (300 μm). Thereafter, the unit was laminated on the fifteen laminated first layers to obtain a specimen.

A treatment of raising the temperature from room temperature to 400° C. in an atmosphere of an oxygen partial pressure of 2×10⁻¹⁰ atm, further raising the temperature to 400 to 850° C. in an atmosphere of an oxygen partial pressure of 5×10⁻¹⁵ atm, and holding the specimen in an atmosphere of an oxygen partial pressure of 5×10⁻¹⁵ atm at a temperature of 850° C. for 1 hour was performed as a heat treatment on the obtained specimen. Note that the oxygen partial pressure was a numerical value measured using an oxygen concentration meter at a sensor temperature of 700° C.

### “Element Mapping Result”

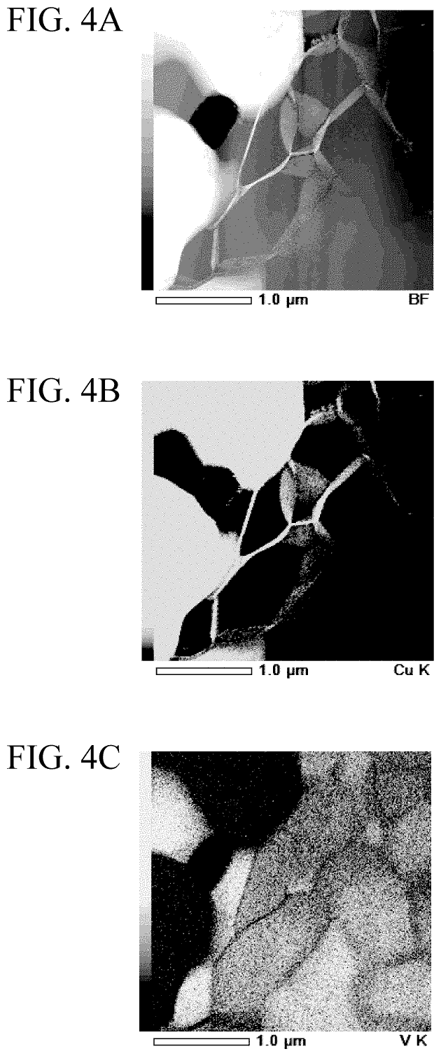

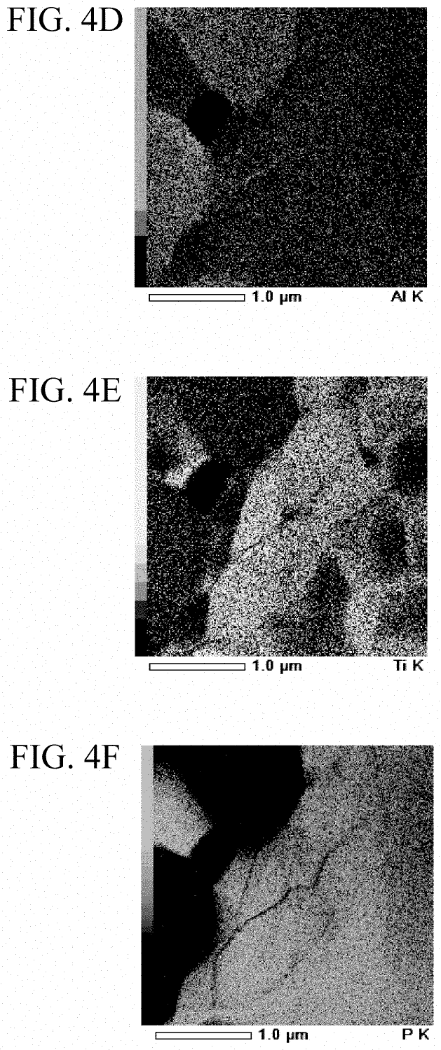

The specimen After The Heat treatment was cut, and energy dispersive X-ray spectroscopy (EDS) was performed on the grain boundaries of the second layer that was present near the third layer in the cut surface. An image of the observed field of view is shown in FIG. 4A, and obtained results of mapping elements Cu, V, Al, Ti, and P are shown in FIGS. 4B to 4F.

As shown in FIGS. 4A to 4F, it was possible to confirm that Cu-containing regions containing Cu at high concentration were formed at the grain boundaries that were present near the third layer.

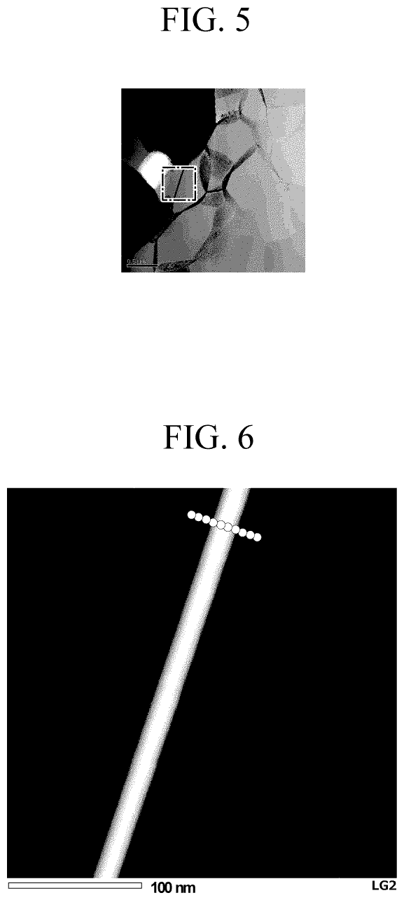

Also, scanning electron microscope (SEM) observation was conducted on the specimen after the heat treatment in the same field of view as those in FIGS. 4A to 4F. FIG. 5 is a scanning electron microscope (SEM) photo of the specimen after the heat treatment in the same field of view as those in FIGS. 4A to 4F. FIG. 6 is an enlarged photo showing a part of FIG. 5 in an enlarged manner and is an enlarged photo within the frame of the dashed line in FIG. 5.

Energy dispersive X-ray spectroscopy (EDS) was conducted at the location represented with circles in FIG. 6. The results are shown in Table 4 and FIG. 7. FIG. 7 is a graph showing a relationship between the distance from an origin (the location of 0.00) that is assumed to be at the leftmost location among the locations represented with the circles in FIG. 6 to the locations represented with the other circles and element concentration at each of the locations. Table 4 shows results of measuring element concentrations at a location of 22.95 nm from the origin.

TABLE 4

| Element | % by mass | % by number of atoms |
|---|---|---|
| O K | 0.8 | 3 |
| Al K | 0 | 0.1 |
| P K | 1 | 2 |
| Ti K | 0.5 | 0.6 |
| V K | 0.7 | 0.8 |
| Cu K | 97 | 93.5 |

As shown in Table 4 and FIG. 7, it was recognized that the white portions shown in FIG. 6 were Cu-containing regions containing Cu at a high concentration and that the amount of Cu in the Cu-containing regions was equal to or greater than 90% by mass.

### REFERENCE SIGNS LIST

1 Positive electrode layer (electrode layer)

1A Positive electrode current collector layer (current collector layer)

1B Positive electrode active material layer (active material layer)

2 Negative electrode layer (electrode layer)

2A Negative electrode current collector layer (current collector layer)

2B Negative electrode active material layer (active material layer)

3 Solid electrolyte layer

4 Layered body

5 First external terminal (terminal electrode)

6 Second external terminal (terminal electrode)

10 All-solid-state lithium ion secondary battery (all-solid-state battery)

21 Cu-containing region

22 Particle

1. An all-solid-state lithium ion secondary battery comprising:
a layered body in which a plurality of electrode layers are laminated with a solid electrolyte layer therebetween, a current collector layer and an active material layer being laminated in each of the electrode layers; and
a terminal electrode that is formed such that the terminal electrode is in contact with a side surface of the layered body from which end surfaces of the electrode layers are exposed,
wherein the terminal electrode contains Cu, and Cu-containing regions are formed at grain boundaries that are present near the terminal electrode among grain boundaries of particles that form the active material layers and the solid electrolyte layer.

2. The all-solid-state lithium ion secondary battery according to claim 1, wherein the terminal electrode contains at least one selected from the group consisting of V, Fe, Ni, Co, Mn, and Ti.

3. The all-solid-state lithium ion secondary battery according to claim 1, wherein a shortest distance between a border of the active material layers or the solid electrolyte layer and the terminal electrode and a Cu-containing region, which extends from the border toward a side of the active material layers or the solid electrolyte layer; and formed in a furthest location is from the boundary is from 0.1 to 50 μm.

4. The all-solid-state lithium ion secondary battery according to claim 1, wherein the solid electrolyte layer contains a compound represented by Formula (1) below:
Li_{f}V_{g}AlₕTiᵢPⱼO₁₂ (1)
wherein f, g, h, i, and j in Formula (1) are numbers that satisfy 0.5≤f≤3.0, 0.01≤g <1.00, 0.09<h≤0.30, 1.40<i≤2.00, and 2.80≤j≤3.20, respectively.

5. The all-solid-state lithium ion secondary battery according to claim 1, wherein at least one electrode layer includes an active material layer containing a compound represented by Formula (2) below:
LiₐV_{b}Al_{c}Ti_{d}P_{c}O₁₂ (2)
wherein a, b, c, d, and e in Formula (2) are numbers that satisfy 0.5≤a≤3.0, 1.20<b≤2.00, 0.01≤c<0.06, 0.01≤d<≤0.60, and 2.80≤e≤3.20, respectively.

6. The all-solid-state lithium ion secondary battery according to claim 1, wherein a relative density of the electrode layer and the solid electrolyte layer is equal to or greater than 80%.
